(19) United States
(12) Patent Application Publication
(10) Pub. No.: US 2023/0419163 A1
(43) Pub. Date: Dec. 28, 2023

(54) COMPUTER TRAINING DATA USING MACHINE LEARNING

(71) Applicant: International Business Machines Corporation, Armonk, NY (US)

(72) Inventors: Zhong Fang Yuan, Xi'an (CN); Tong Liu, Xi'an (CN); Wen Wang, Beijing (CN); Xiang Yu Yang, xi'an (CN); Cheng Gang Hu, Chuzhou (CN)

(21) Appl. No.: 17/809,463

(22) Filed: Jun. 28, 2022

(51) Int. Cl. G06N 20/00

(52) U.S. Cl. CPC G06N 20/00

(57) ABSTRACT

Training data models using machine learning can include training a computer data model of data distribution using a training data set. The training data set includes training data and additional training data, and the training data and the additional training data being represented by layers of data representing the data distribution of the training data set. The computer data model using the additional training data is iteratively trained for each of the layers of the training data set. Statistical noise is added randomly to each of the layers of the training data set. Data variations are detected in each of the layers of the additional training data. The data variations are diluted in each of the additional layers of the training data, and the computer data model is retrained for the training data set using the diluted data variations in each of the layers of the additional training data.

### BACKGROUND

The present disclosure relates to computer training of electronic data using machine learning and/or artificial intelligence (AI) based on computer generated algorithms for generating models and balancing distributed data.

In one example, in industrial deep learning, an online model may regularly absorb real usage data from the real environment as incremental data for incremental training of the model. Most of these incremental data are semi-automatically verified by manual verifiers using historical models, then added to the training data, and combined with historical training data as new training data for iterative training of the model. However, in the iterative process, there is often an accumulation phenomenon of errors. The accumulation phenomenon includes the data and model behaving normally during a long part of the iteration cycle, but after a certain iteration, the model produced by the iteration will suddenly fail in reasoning and confusion of confidence. One reason for this phenomenon is due to long-term data accumulation rather than a certain iterative data update, so it is difficult to monitor it by manual or traditional automated monitoring algorithms.

In the following example of this phenomenon, in a sentiment analysis project, the purpose of the project is to divide text into two types: a positive sentiment or a negative sentiment. In each iteration, the positive and negative emotion data can be constantly updated. After many iterations, the model appears to be biased, and then the user enters any sentence with a word or word phrase, the algorithm will treat it as a positive emotion and ignore other words. After analysis, each iteration added to the training data corresponding to the positive emotions has a fixed phrase of the word. The phrase word is not a problem from the perspective of reviewers or traditional review algorithms, but when this fixed phrase is added for a long time, the deep learning algorithm will treat the phrase as a typical feature of the label of positive emotion.

### SUMMARY

The present disclosure recognizes the shortcomings and problems associated with current techniques for computer training of electronic data using machine learning and/or artificial intelligence (AI).

In one example according to the present invention, accumulation phenomenon or chronic accumulation phenomenon may not only appear in the natural language processing scenario. For example, accumulation phenomenon can be extensive in computer vision, industrial machine learning and other scenarios, and can be difficult to recognize compared to natural language processing. For example, if images are added to a training set recognition in large numbers, the model may cause confusion in distinguishing between images, because one image can be embedded with another images and may not be sensitive to the naked eye, but sensitive to computer algorithms. A similar phenomenon occurs in industrial machine learning and this phenomenon can be more serious as the data set becomes more specialized.

In an aspect according to the present invention, a computer-implemented method for training data models using machine learning includes training a computer data model of data distribution using a training data set. The training data set can include training data and additional training data, and the training data and the additional training data can be represented by layers of data representing the data distribution of the training data set. The method can include iteratively training the computer data model using the additional training data for each of the layers of the training data set, and adding statistical noise randomly to each of the layers of the training data set. The method includes detecting data variations in each of the layers of the additional training data, and diluting the data variations in each of the additional layers of the training data. The method includes retraining the computer data model for the training data set using the diluted data variations in each of the layers of the additional training data.

In a related aspect, the additional data is selected using parameters, for each of the layers of data, respectively.

In a related aspect, the method further includes identifying a principal component of the data variations.

In a related aspect, the method further includes identifying a principal component of the data variations; and adding a principal component of the data variations to each of the layers of the training data set, as at least part of the diluting of the data variations in each of the additional layers of the training data set.

In a related aspect, the adding of the statistical noise is implemented using an adversarial generation network, wherein a generator randomly generates the statistical noise and merges it with the parameters at each layer of the training data set.

In a related aspect, the detecting of data variations in each of the layers of the additional training data includes detecting outlier data points in response to generating iterations of the computer model.

In a related aspect, the statistical noise is Gaussian noise.

In another aspect according to the invention, a system for training data models uses machine learning and includes a computer system. The computer system includes a computer processor, a computer-readable storage medium, and program instructions stored on the computer-readable storage medium being executable by the processor, to cause the computer system to perform the following functions to; train a computer data model of data distribution using a training data set, the training data set including training data and additional training data, the training data and the additional training data being represented by layers of data representing the data distribution of the training data set; iteratively train the computer data model using the additional training data for each of the layers of the training data set; add statistical noise randomly to each of the layers of the training data set; detect data variations in each of the layers of the additional training data; dilute the data variations in each of the additional layers of the training data; and retrain the computer data model for the training data set using the diluted data variations in each of the layers of the additional training data.

In a related aspect, the additional data can be selected using parameters, for each of the layers of data, respectively.

In a related aspect, the system can further include identifying a principal component of the data variations.

In a related aspect, the system can further include the following function to: identify a principal component of the data variations; and add a principal component of the data variations to each of the layers of the training data set, as at least part of the diluting of the data variations in each of the additional layers of the training data set.

In a related aspect, the adding of the statistical noise is implemented using an adversarial generation network, wherein a generator randomly generates the statistical noise and merges it with the parameters at each layer of the training data set.

In a related aspect, the detection of data variations in each of the layers of the additional training data includes the function to detect outlier data points in response to generating iterations of the computer model.

In a related aspect, the statistical noise is Gaussian noise.

In another aspect according to the present invention, a computer program product for training data models using machine learning includes a computer readable storage medium having program instructions embodied therewith. The program instructions are executable by a computer to cause the computer to perform functions, by the computer, comprising the functions to; train a computer data model of data distribution using a training data set, the training data set including training data and additional training data, the training data and the additional training data being represented by layers of data representing the data distribution of the training data set; iteratively train the computer data model using the additional training data for each of the layers of the training data set; add statistical noise randomly to each of the layers of the training data set; detect data variations in each of the layers of the additional training data; dilute the data variations in each of the additional layers of the training data; and retrain the computer data model for the training data set using the diluted data variations in each of the layers of the additional training data.

In a related aspect, the additional data can be selected using parameters, for each of the layers of data, respectively.

In a related aspect, the computer program product can further include the function to: identify a principal component of the data variations.

In a related aspect, the computer program product can further include the functions to: identify a principal component of the data variations; and add a principal component of the data variations to each of the layers of the training data set, as at least part of the diluting of the data variations in each of the additional layers of the training data set.

In a related aspect, the adding of the statistical noise is implemented using an adversarial generation network, and wherein a generator randomly generates the statistical noise and merges it with the parameters at each layer of the training data set.

In a related aspect, the function to detect data variations in each of the layers of the additional training data includes detecting outlier data points in response to generating iterations of the computer model.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. The drawings are discussed forthwith below.

FIG. 1A is a schematic block diagram graph illustrating interactions of model training sets of data without data mutation, according to an embodiment of the present disclosure.

FIG. 1B is a schematic block diagram graph illustrating iterations of model training sets of data including data mutation, according to an embodiment of the present disclosure.

FIG. 2 is a schematic block diagram graph comparing data distribution including data mutation, according to an embodiment of the present disclosure.

FIG. 3 is a functional schematic block diagram depicting a model using difference tensors and constants, according to an embodiment of the present disclosure.

FIG. 4 is a schematic block diagram graph illustrating a grouping of data and data mutation, according to the present disclosure.

FIG. 5 is a functional schematic block diagram illustrating a system according to an embodiment of the present invention, for computer model training of data using machine language for detecting and compensating for data mutation.

FIG. 6 is a flow chart illustrating a method according to an embodiment of the present invention, for computer model training of data using machine language for detecting and compensating for data mutation.

FIG. 7 is a schematic block diagram depicting a computer system according to an embodiment of the disclosure which may be incorporated, all or in part, in one or more computers or devices shown in other figures, and cooperates with the systems and methods shown in the figures.

FIG. 8 is a schematic block diagram of a system depicting system components interconnected using a bus. The components for use, in all or in part, with the embodiments of the present disclosure, in accordance with one or more embodiments of the present disclosure.

FIG. 9 is a block diagram depicting a cloud computing environment according to an embodiment of the present invention.

FIG. 10 is a block diagram depicting abstraction model layers according to an embodiment of the present invention.

### DETAILED DESCRIPTION

The following description with reference to the accompanying drawings is provided to assist in a comprehensive understanding of exemplary embodiments of the invention as defined by the claims and their equivalents. The description includes various specific details to assist in that understanding, but these are to be regarded as merely exemplary, and assist in providing clarity and conciseness. Accordingly, those of ordinary skill in the art will recognize that various changes and modifications of the embodiments described herein can be made without departing from the scope and spirit of the invention. In addition, descriptions of well-known functions and constructions may be omitted.

The terms and words used in the following description and claims are not limited to the bibliographical meanings, but are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

### EMBODIMENTS AND EXAMPLES

Embodiments and figures of the present disclosure may have the same or similar components as other embodiments. Such figures and descriptions illustrate and explain further examples and embodiments according to the present disclosure. Embodiments of the present disclosure can include operational actions and/or procedures. A method, such as a computer-implemented method, can include a series of operational blocks for implementing an embodiment according to the present disclosure which can include cooperation with one or more systems shown in the figures. The operational blocks of the methods and systems according to the present disclosure can include techniques, mechanism, modules, and the like for implementing the functions of the operations in accordance with the present disclosure. Similar components may have the same reference numerals. Components can operate in concert with a computer implemented method.

Chronic accumulation of errors can be described as a phenomenon in which newly-added data has an obvious tendency. For example, a method of data injection affects the overall data distribution, and finally causes a data distribution mutation at a certain point in time, which leads to a phenomenon in which the model inference effect decreases. In response to this issue, a method and system according to the present disclosure can implement a measurement method and/or system based on a degree of change of model parameters representing a degree of data distribution mutation. By measuring the degree of change of model parameters in an iterative period, it is possible to find a data distribution mutation or discontinuity. Then a mutation principal component dilution method can be used to eliminate mutations in data distribution.

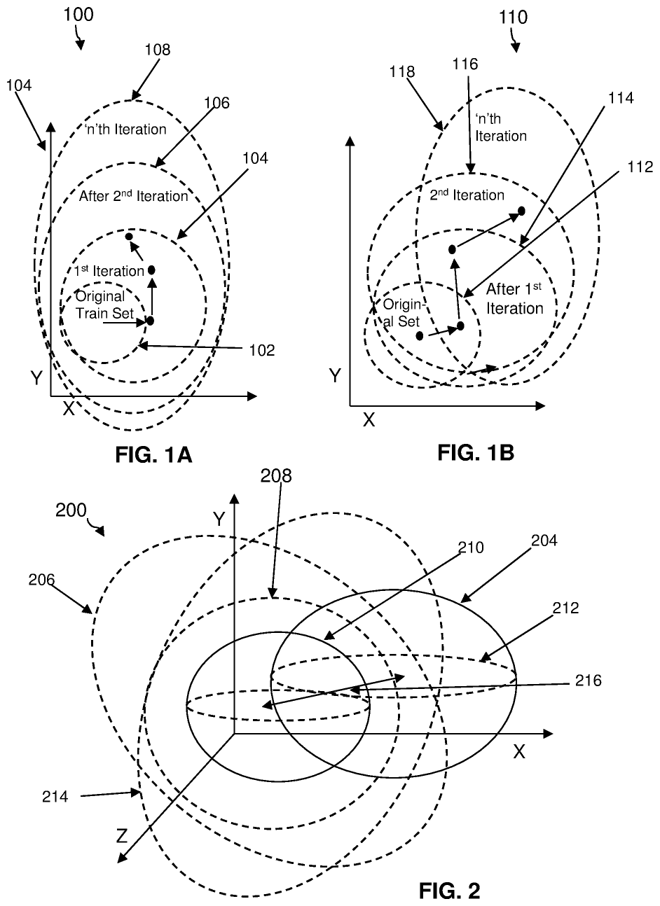

Referring to FIG. 1A, a diagram 100 includes an X axis and Y axis. The diagram 100 shows a data distribution change of data iterations under normal conditions. The diagram shown iterative data distribution without data mutation. Referring to FIG. 1B, a diagram 110 also includes an X axis and a Y axis. The diagram shows iterative data distribution change when data mutation occurs. As a result of a change in the data distribution, for example, a sudden change of data, an original data training set shown in the diagram 100 can become an outlier in an overall data set to some degree, as shown in diagram 110.

Referring to FIG. 2, a diagram 200 having a X axis, a Y axis, and a Z axis depicts data distribution using a center of gravity comparison 216 of the data distribution under normal conditions and a model of data distribution after a mutation. The diagram 200 depicts computer generating models to model jitter to simulate changes in data after iteration under normal conditions. The diagram 200 uses a model jitter under threshold constraint operation including a model jitter A 208 and a model jitter B 214 and a model jitter C 206, to simulate changes after a data iteration under normal conditions. And the diagram 200 depicts a center of gravity comparison 216 with the model parameters after the data mutation 206 between the original model 210 and the model after data iteration 204.

In one example, a method according to the present disclosure includes detecting the suspected data mutation points in the iterative process, and using the data before the suspected data mutation points to extract the principal components of the data mutation. After the principal component of data variation is obtained, the effect of diluting the principal component of data variation is achieved by adding the principal component of data variation to each category in the data. After the mutation data is diluted, the diluted data can be used to retrain the model, which can effectively prevent the problem of chronic error accumulation.

A method and system according to the present disclosure can include two operations. The first operation is directed to how to determine data distribution mutation points, and can include the following. When a model is trained with training data and finally fitted, the parameters of the model can be regarded as a representation of the data distribution of this set of training data. Therefore, after each round of data iteration, the projection of the parameters of the model trained with the iterated data in the vector space can be regarded as the distribution of this set of training data. The distribution of the training data itself is not used because the magnitude of the training data is much larger than the parameter of the model, and the parameters of the model can be regulated by various mathematical formulas, so it is preferred to be fitted by the standard data distribution (such as a normal distribution). Each layer parameter of the model trained after iteration is randomly added with additive noise or signal noise. The noise can be used to mimic the effects of many random processes that occur naturally. The noise can include a normal distribution in a time domain with an average time domain value of zero. The normal distribution can be, for example, Gaussian or Gaussian noise, or can include Laplace-Gauss distribution, as a type of continuous probability distribution for a real-valued random variable.

The addition of Gaussian noise is the process of iterating the simulation model and updating the parameters. The parameters of the model can represent the distribution of the data, so the iteration of the simulation model can also be regarded as the iteration of the simulation data, the change of the data distribution. Also included in this operation, in order to avoid abnormal changes in the data distribution caused by random Gaussian noise, a constraint can be added, that is, each simulation iteration of the model must use the first training set for regression testing to obtain all single data through the model's confidence. If the model's confidence is not significantly lower than before, the simulation result will be retained, otherwise, the simulation result will not be retained. The constraint ensures that the data distribution changes after each simulation are changes under normal conditions, and there is no data mutation. The method of adding random Gaussian noise is implemented using an adversarial generation network, in which the Generator randomly generates Gaussian noise and merges it with the parameters of each layer of the model. Discriminator is responsible for the constraint condition part. Thus, constrained jitter of the model in the vector space is implemented. Each jitter enumerates the possibility of the normal development of the data distribution from a random direction.

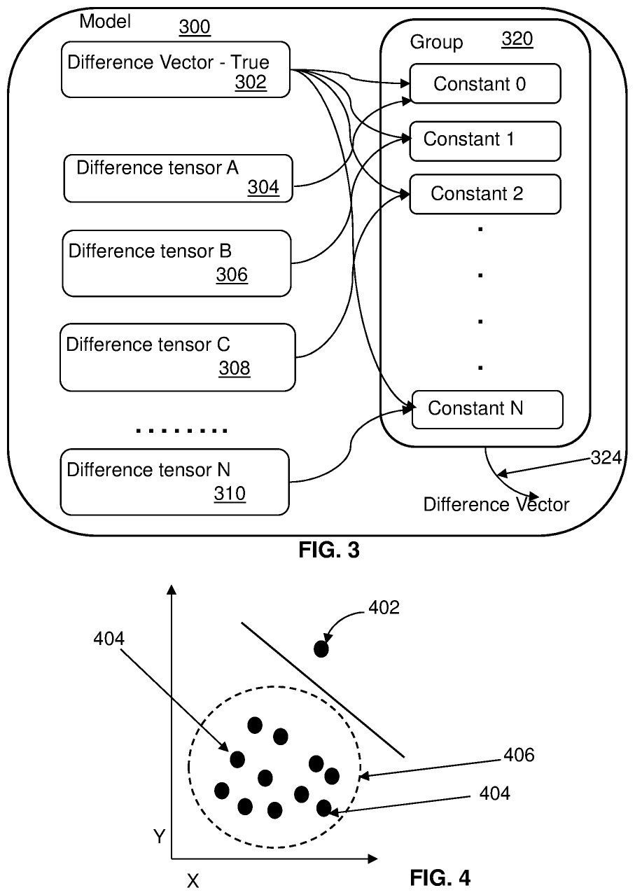

Referring to FIGS. 3 and 4, simulation models through the model constrained jitter are strictly constrained non-abrupt models. Before using real data to iterate the model at each step, multiple (for example, 300 times) models with unconstrained jitter can be generated. After completing the unconstrained jitter of the model, a real iterative model can be used to perform parameter subtraction with the simulation model layer by layer. The parameter subtraction can get a plurality of tensors. The tensors are the real development direction of the model and the development direction of the simulation. For example, in a model 300, a difference vector—true 302, difference tensor A 304, difference tensor B 306, difference vector C 308, continue to difference vector N 310. The difference between is recorded as the difference tensor. At the same time, we also use the real iterative model to do the same operation as the model in the previous step to get a difference tensor. This tensor is the difference variable of the model in the real scene, which is recorded as the difference tensor-True. Comparing the real difference tensor-true with the simulated difference tensor (such as cosine similarity), a difference value is obtained, and the difference value is a constant. For example, group 320 can include constant 0, constant 1, constant 2, continuing to constant N. All the difference values in the comparison result can form a difference value vector 324 as a whole. This difference value vector represents the difference between the new training data distribution and the old training data distribution in the three dimensional space from the perspective of the model. Under normal circumstances, after N iterations, N difference vectors will be produced, for example N difference vector 324. Under normal circumstances, these N difference vectors should be cohesive in space, that is, a dense cluster. But if there is a variation in the data distribution, for example, data points 404 as represented in a data cluster 406 along an X and Y axes. Outliers will appear in the N difference vectors, and since the outliers between vectors are measured, KNN (k nearest neighbor (KNN) is a classification algorithm) or single-pass to detect outliers is used, such as outlier data point 402. If an outlier is obtained in a certain iteration, we know that there is a high probability (the probability is equal to the confidence of whether there is an outlier) of a data mutation in this iteration.

Again referring to FIGS. 3 and 4 outliers in a certain iteration can indicate that there is a high probability that data mutations will occur in this iteration. A response to the data mutation phenomenon is to eliminate the data mutation. The response method can include determining the iterative round in which data mutation is suspected as the watershed, and only the data before that round is used in the following process. The process includes training n classifiers, and each classifier distinguishes a certain type from other types. A total of N−1 classifiers are obtained in this step. The process includes classifying all data according to a label, applying principal component analysis (PCA) to all the data under each label, separate the top principal components (for example the top ten), and normalize them into the same feature map shape as the standard data. The process includes using the remaining models to infer the principal components obtained in the operation above, and observe their confidence. If there is a phenomenon that the confidence of the principal component inference is significantly higher (that is, the principal component is a strong feature compared to other types of classifiers), it is considered that this principal component may be the main reason for the data mutation. The process includes adding the obtained principal component of suspected mutation evenly to all categories to dilute the strong tendency caused by this principal component during classification.

In general, advantages can include using the jitter operation of the model parameters in the vector space, the possible distribution of a large amount of real data in the future is simulated, which lays the data foundation for the subsequent data distribution inference. In another aspect, the data mutation point can be calculated from the outliers of the difference vector, and the time node where the data problem occurs can be inferred. In another aspect, using the method of principal component dilution is used to repair the data with data mutation at the feature level.

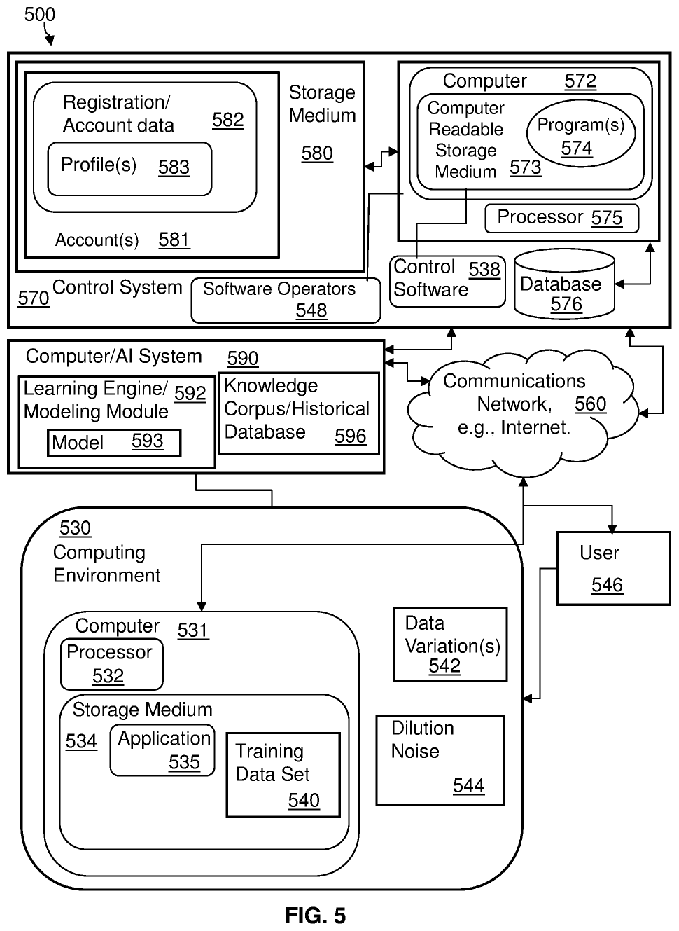

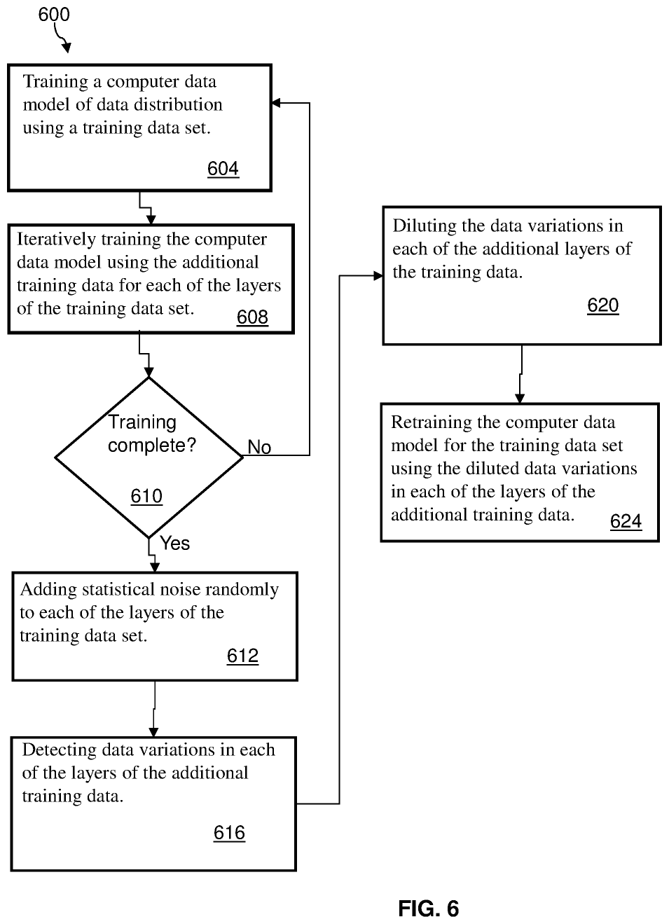

Referring to FIGS. 5 and 6, according to an embodiment of the present disclosure, a computer-implemented method 600 for training data models using machine learning replicating a software cluster, including control software and containers, in another computing environment, includes features described below, and reference the system 500 shown in FIG. 5. In one example, machine learning can be embodied as a learning engine 592 of a computer and/or an AI system 590, where the learning engine can generate a model 593.

The method 600 includes, training a computer data model of data distribution using a training data set 540, as in block 604. The training data set can include training data 540 and additional training data. The training data and the additional training data can be represented by layers of data representing the data distribution of the training data set.

The method includes iteratively training the computer data model using the additional training data for each of the layers of the training data set, as in block 608. If the training is determined to not be complete in block 610, the method can return to block 604. If the training is determined to be complete, the method can proceed to block 612.

The method includes adding statistical noise randomly to each of the layers of the training data set, as in block 612. The method further includes detecting data variations 542 in each of the layers of the additional training data, as in block 616. The method includes diluting the data variations in each of the additional layers of the training data, as in block 620, with dilution noise 544 such as statistical noise, for example Gaussian noise. The method includes retraining the computer data model for the training data set using the diluted data variations in each of the layers of the additional training data, as in block 624.

In one example, the additional data can be selected using parameters, for each of the layers of data, respectively. In another example, the method can include identifying a principal component of the data variations. In another example, the method can include identifying a principal component of the data variations. Further, the method can include adding a principal component of the data variations to each of the layers of the training data set, as at least part of the diluting of the data variations in each of the additional layers of the training data set.

In another example, the adding of the statistical noise is implemented using an adversarial generation network, wherein a generator randomly generates the statistical noise and merges it with the parameters at each layer of the training data set. In another example, the detecting of data variations in each of the layers of the additional training data includes detecting outlier data points in response to generating iterations of the computer model. In one example, the statistical noise can be Gaussian noise.

### ADDITIONAL EXAMPLES AND EMBODIMENTS

Referring to the figures, and for example, FIG. 5, a computer 531 can be in a computing environment 530 such as electronically communicating with peripheral devices, for example, monitors, input/output device, etc. A computer 572 remote from the computer or device 531 can electronically communicate, in all or in part, with the computer 572 as part of a control system 570. The control system can include the computer 572 having a computer readable storage medium 573 which can store one or more programs 574, and a processor 575 for executing program instructions. The control system can also include a storage medium which can include registration and/or account data 582 and profiles 583 of users or entities (such entities can include robotic entities) as part of user accounts 581. User accounts 581 can be stored on a storage medium 580 which is part of the control system 570. The user accounts 581 can include registrations and account data 582 and user profiles 583. The control system can also include a computer 572 having a computer readable storage medium 573 which can store programs or code embedded on the storage medium. The program code can be executed by a processor 575. The computer 572 can communicate with a database 576. The control system 570 can also include a database 576 for storing all or part of such data as described above, and other data.

The control system can also communicate with a computer system 590 which can include a learning engine/module 592 and a knowledge corpus or database 596. The computer system 590 can also communicate with the computer 531 and can be remote from a user device used by a user 546. In another example, the computer system 590 can be all or part of the control system, or all or part of a device. The depiction of the computer system 590 as well as the other components of the system 500 are shown as one example according to the present disclosure. One or more computer systems can communicate with a communications network 560, e.g., the Internet. For example, the computer 590, and the control system 570 can communicate with the communications network 560, and the device/computer 531 can communicate with a local communications network which can communicate with the communications network 560.

In one example, a new or different AI (Artificial Intelligence) ecosystem, or technology/communication or IT (Information Technology) ecosystem can include a local communications network which can communicate with the communications network 560. The system 500 can include a learning engine/module 592, which can be at least part of the control system or communicating with the control system, for generating a model 593 or learning model. In one example, the learning model can model workflow in a new AI or IoT (Internet of Things) ecosystem for machine/devices in the new ecosystem.

In another example, the computer 531 can be part of a device. The computer can include a processor 532 and a computer readable storage medium 534 where an application 535 can be stored which can in one example, embody all or part of the method of the present disclosure. The application can include all or part of instructions to implement the method of the present disclosure, embodied in code and stored on a computer readable storage medium. The computer 531 can be part independent or part of a device, and can communicate with a display. The device can operate, in all or in part, in conjunction with a remote server by way of a communications network 160, for example, the Internet.

The method can include an analysis generating a model 593 based on received data. A model can also be generated by an AI system, at least in part. In one example, an AI system can generate a model using an AI system analysis using machine learning.

In other embodiments and examples, in the present disclosure shown in the figures, a computer can be part of a remote computer or a remote server, for example, a remote server. In another example, the computer can be part of a control system and provide execution of the functions of the present disclosure. In another embodiment, a computer can be part of a mobile device and provide execution of the functions of the present disclosure. In still another embodiment, parts of the execution of functions of the present disclosure can be shared between the control system computer and the mobile device computer, for example, the control system function as a back end of a program or programs embodying the present disclosure and the mobile device computer functioning as a front end of the program or programs. A device(s), for example a mobile device or mobile phone, can belong to one or more users, and can be in communication with the control system via the communications network.

The computer can be part of the mobile device, or a remote computer communicating with the mobile device. In another example, a mobile device and a remote computer can work in combination to implement the method of the present disclosure using stored program code or instructions to execute the features of the method(s) described herein. In one example, the device can include a computer having a processor and a storage medium which stores an application, and the computer includes a display. The application can incorporate program instructions for executing the features of the present disclosure using the processor. In another example, the mobile device application or computer software can have program instructions executable for a front end of a software application incorporating the features of the method of the present disclosure in program instructions, while a back end program or programs, of the software application, stored on the computer of the control system communicates with the mobile device computer and executes other features of the method. The control system and the device (e.g., mobile device or computer) can communicate using a communications network, for example, the Internet.

Thus, in one example, a control system can be in communication with a computer or device, and the computer can include an application or software. The computer, or a computer in a mobile device can communicate with the control system using the communications network. In another example, the control system can have a front-end computer belonging to one or more users, and a back-end computer embodied as the control system.

Methods and systems according to embodiments of the present disclosure, can be incorporated in one or more computer programs or an application stored on an electronic storage medium, and executable by the processor, as part of the computer on mobile device. For example, a mobile device can communicate with the control system, and in another example, a device such as a video feed device can communicate directly with the control system. Other users (not shown) may have similar mobile devices which communicate with the control system similarly. The application can be stored, all or in part, on a computer or a computer in a mobile device and at a control system communicating with the mobile device, for example, using the communications network, such as the Internet. It is envisioned that the application can access all or part of program instructions to implement the method of the present disclosure. The program or application can communicate with a remote computer system via a communications network (e.g., the Internet) and access data, and cooperate with program(s) stored on the remote computer system. Such interactions and mechanisms are described in further detail herein and referred to regarding components of a computer system, such as computer readable storage media, which are shown in one or more embodiments herein and described in more detail in regards thereto referring to one or more computers and systems described herein.

Also, referring to the figures, a device can include a computer, computer readable storage medium, and operating systems, and/or programs, and/or a software application, which can include program instructions executable using a processor. Embodiments of these features are shown herein in the figures. The method according to the present disclosure, can include a computer for implementing the features of the method, according to the present disclosure, as part of a control system. In another example, a computer as part of a control system can work in corporation with a mobile device computer in concert with communication system for implementing the features of the method according to the present disclosure. In another example, a computer for implementing the features of the method can be part of a mobile device and thus implement the method locally.

The control system can include a storage medium for maintaining a registration of users and their devices for analysis of the audio input. Such registration can include user profiles, which can include user data supplied by the users in reference to registering and setting-up an account. In an embodiment, the method and system which incorporates the present disclosure includes the control system (generally referred to as the back-end) in combination and cooperation with a front end of the method and system, which can be the application. In one example, the application is stored on a device, for example, a computer or device on location, and can access data and additional programs at a back end of the application, e.g., control system.

The control system can also be part of a software application implementation, and/or represent a software application having a front-end user part and a back-end part providing functionality. In an embodiment, the method and system which incorporates the present disclosure includes the control system (which can be generally referred to as the back-end of the software application which incorporates a part of the method and system of an embodiment of the present application) in combination and cooperation with a front end of the software application incorporating another part of the method and system of the present application at a device or computer. The application is stored on the device or computer and can access data and additional programs at the back end of the application, for example, in the program(s) stored in the control system.

The program(s) can include, all or in part, a series of executable steps for implementing the method of the present disclosure. A program, incorporating the present method, can be all or in part stored in the computer readable storage medium on the control system or, in all or in part, on a computer or device. It is envisioned that the control system can not only store the profile of users, but in one embodiment, can interact with a website for viewing on a display of a device such as a mobile device, or in another example the Internet, and receive user input related to the method and system of the present disclosure. It is understood that embodiments shown in the figures depicts one or more profiles, however, the method can include multiple profiles, users, registrations, etc. It is envisioned that a plurality of users or a group of users can register and provide profiles using the control system for use according to the method and system of the present disclosure.

In one example, as part of the analysis of received data including data in the knowledge corpus and historical database, which can be populated by historical data gathered, for example, from sensors, robotic device, or other machines or devices.

Referring to one or more embodiments in the figures, a computer or a device, also can be referred to as a user device or an administrator's device, includes a computer having a processor and a storage medium where an application can be stored. The application can embody the features of the method of the present disclosure as instructions. The user can connect to a learning engine using the device. The device which includes the computer and a display or monitor. The application can embody the method of the present disclosure and can be stored on the computer readable storage medium. The device can further include the processor for executing the application/software. The device can communicate with a communications network, e.g., the Internet.

It is understood that the user device is representative of similar devices which can be for other users, as representative of such devices, which can include, mobile devices, smart devices, laptop computers etc.

In one example, the system of the present disclosure can include a control system 570 communicating with a user device via a communications network 560. The control system can incorporate all or part of an application or software for implementing the method of the present disclosure. The control system can include a computer readable storage medium 580 where account data and/or registration data 582 can be stored. User profiles 583 can be part of the account data and stored on the storage medium 580. The control system can include a computer 572 having computer readable storage medium 573 and software programs 574 stored therein. A processor 575 can be used to execute or implement the instructions of the software program. The control system can also include a database 576.

In another example and embodiment, profiles can be saved for entities such as users, participants, operators, human operators, or robotic devices. Such profiles can supply data regarding the user and history of deliveries for analysis. In one example, a user can register or create an account using the control system which can include one or more profiles as part of registration and/or account data. The registration can include profiles for each user having personalized data. For example, users can register using a website via their computer and GUI (Graphical User Interface) interface. The registration or account data can include profiles for an account for each user. Such accounts can be stored on the control system, which can also use the database for data storage. A user and a related account can refer to, for example, a person, or an entity, or a corporate entity, or a corporate department, or another machine such as an entity for automation such as a system using, in all or in part, artificial intelligence.

Additionally, methods and systems according to embodiments of the present disclosure can be discussed in relation to a functional system(s) depicted by functional block diagrams. The methods and systems can include components and operations for embodiments according to the present disclosure, and is used herein for reference when describing the operational steps of the methods and systems of the present disclosure. Additionally, the functional system, according to an embodiment of the present disclosure, depicts functional operations indicative of the embodiments discussed herein.

### MORE EXAMPLES AND EMBODIMENTS

The methods and systems of the present disclosure can include a series of operational blocks for implementing one or more embodiments according to the present disclosure. A method shown in the figures may be another example embodiment, which can include aspects/operations shown in another figure and discussed previously, but can be reintroduced in another example. Thus, operational blocks and system components shown in one or more of the figures may be similar to operational blocks and system components in other figures. The diversity of operational blocks and system components depict example embodiments and aspects according to the present disclosure. For example, methods shown are intended as example embodiments which can include aspects/operations shown and discussed previously in the present disclosure, and in one example, continuing from a previous method shown in another flow chart.

It is understood that the features shown in some of the figures, for example block diagrams, are functional representations of features of the present disclosure. Such features are shown in embodiments of the systems and methods of the present disclosure for illustrative purposes to clarify the functionality of features of the present disclosure.

### FURTHER DISCUSSION REGARDING EXAMPLES AND EMBODIMENTS

It is understood that a set or group is a collection of distinct objects or elements. The objects or elements that make up a set or group can be anything, for example, numbers, letters of the alphabet, other sets, a number of people or users, and so on. It is further understood that a set or group can be one element, for example, one thing or a number, in other words, a set of one element, for example, one or more users or people or participants. It is also understood that machine and device are used interchangeable herein to refer to machine or devices in one or ecosystems or environments, which can include, for example and artificial intelligence (AI) environment.

### STILL FURTHER EMBODIMENTS AND EXAMPLES

A computer implemented method as disclosed herein can include modeling, using the computer. The model can be generated using a learning engine or modeling module of a computer system which can be all or in part of an Artificial Intelligence (AI) system which communicates with the computer and/or a control system. Such a computer system can include or communicate with a knowledge corpus or historical database. In one example, an acceptable model can include a model meeting specified parameters. In another example, an acceptable model can be a model which has undergone several iterations of modeling. When the model is not acceptable, the method can return to return to a previous operation or proceed as directed, for example as represented by a operational block in a flowchart.

In one example according to the present disclosure, a method can generate a model, using a computer, which can include a series of operations. The model can be generated using a learning engine or modeling module of a computer system which can be all or in part of an Artificial Intelligence (AI) system which communicates with a computer and/or a control system. Such a computer system can include or communicate with a knowledge corpus or historical database.

The model can be generated using a learning engine or modeling module of a computer system which can be all or in part of an Artificial Intelligence (AI) system which communicates with a computer and/or a control system. Such a computer system can include or communicate with a knowledge corpus or historical database. A model can also be generated by an AI system such as an output at least in part of an AI system analysis using machine learning.

### ADDITIONAL EMBODIMENTS AND EXAMPLES

Account data, for instance, including profile data related to a user, and any data, personal or otherwise, can be collected and stored, for example, in a control system. It is understood that such data collection is done with the knowledge and consent of a user, and stored to preserve privacy, which is discussed in more detail below. Such data can include personal data, and data regarding personal items.

In one example a user can register have an account with a user profile on a control system. For example, data can be collected using techniques as discussed above, for example, using cameras, and data can be uploaded to a user profile by the user. A user can include, for example, a corporate entity, or department of a business, or a homeowner, or any end user, a human operator, or a robotic device, or other personnel of a business.

Regarding collection of data with respect to the present disclosure, such uploading or generation of profiles is voluntary by the one or more users, and thus initiated by and with the approval of a user. Thereby, a user can opt-in to establishing an account having a profile according to the present disclosure. Similarly, data received by the system or inputted or received as an input is voluntary by one or more users, and thus initiated by and with the approval of the user. Thereby, a user can opt-in to input data according to the present disclosure. Such user approval also includes a user's option to cancel such profile or account, and/or input of data, and thus opt-out, at the user's discretion, of capturing communications and data. Further, any data stored or collected is understood to be intended to be securely stored and unavailable without authorization by the user, and not available to the public and/or unauthorized users. Such stored data is understood to be deleted at the request of the user and deleted in a secure manner. Also, any use of such stored data is understood to be, according to the present disclosure, only with the user's authorization and consent.

In one or more embodiments of the present invention, a user(s) can opt-in or register with a control system, voluntarily providing data and/or information in the process, with the user's consent and authorization, where the data is stored and used in the one or more methods of the present disclosure. Also, a user(s) can register one or more user electronic devices for use with the one or more methods and systems according to the present disclosure. As part of a registration, a user can also identify and authorize access to one or more activities or other systems (e.g., audio and/or video systems). Such opt-in of registration and authorizing collection and/or storage of data is voluntary and a user may request deletion of data (including a profile and/or profile data), un-registering, and/or opt-out of any registration. It is understood that such opting-out includes disposal of all data in a secure manner. A user interface can also allow a user or an individual to remove all their historical data.

### OTHER ADDITIONAL EMBODIMENTS AND EXAMPLES

In one example, Artificial Intelligence (AI) can be used, all or in part, for generating a model or a learning model as discussed herein in embodiments of the present disclosure. An Artificial Intelligence (AI) System can include machines, computer, and computer programs which are designed to be intelligent or mirror intelligence. Such systems can include computers executing algorithms. AI can include machine learning and deep learning. For example, deep learning can include neural networks. An AI system can be cloud based, that is, using a cloud-based computing environment having computing resources. In another example, a control system can be all or part of an Artificial Intelligence (AI) system. For example, the control system can be one or more components of an AI system.

It is also understood that methods and systems according to embodiments of the present disclosure, can be incorporated into (Artificial Intelligence) AI devices, components or be part of an AI system, which can communicate with respective AI systems and components, and respective AI system platforms. Thereby, such programs or an application incorporating the method of the present disclosure, as discussed above, can be part of an AI system. In one embodiment according to the present invention, it is envisioned that the control system can communicate with an AI system, or in another example can be part of an AI system. The control system can also represent a software application having a front-end user part and a back-end part providing functionality, which can in one or more examples, interact with, encompass, or be part of larger systems, such as an AI system. In one example, an AI device can be associated with an AI system, which can be all or in part, a control system and/or a content delivery system, and be remote from an AI device. Such an AI system can be represented by one or more servers storing programs on computer readable medium which can communicate with one or more AI devices. The AI system can communicate with the control system, and in one or more embodiments, the control system can be all or part of the AI system or vice versa.

It is understood that as discussed herein, a download or downloadable data can be initiated using a voice command or using a mouse, touch screen, etc. In such examples a mobile device can be user initiated, or an AI device can be used with consent and permission of users. Other examples of AI devices include devices which include a microphone, speaker, and can access a cellular network or mobile network, a communications network, or the Internet, for example, a vehicle having a computer and having cellular or satellite communications, or in another example, IoT (Internet of Things) devices, such as appliances, having cellular network or Internet access.

The descriptions of the various embodiments of the present invention have been presented for purposes of illustration, but are not intended to be exhaustive or limited to the embodiments disclosed. Likewise, examples of features or functionality of the embodiments of the disclosure described herein, whether used in the description of a particular embodiment, or listed as examples, are not intended to limit the embodiments of the disclosure described herein, or limit the disclosure to the examples described herein. Such examples are intended to be examples or exemplary, and non-exhaustive. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### FURTHER ADDITIONAL EXAMPLES AND EMBODIMENTS

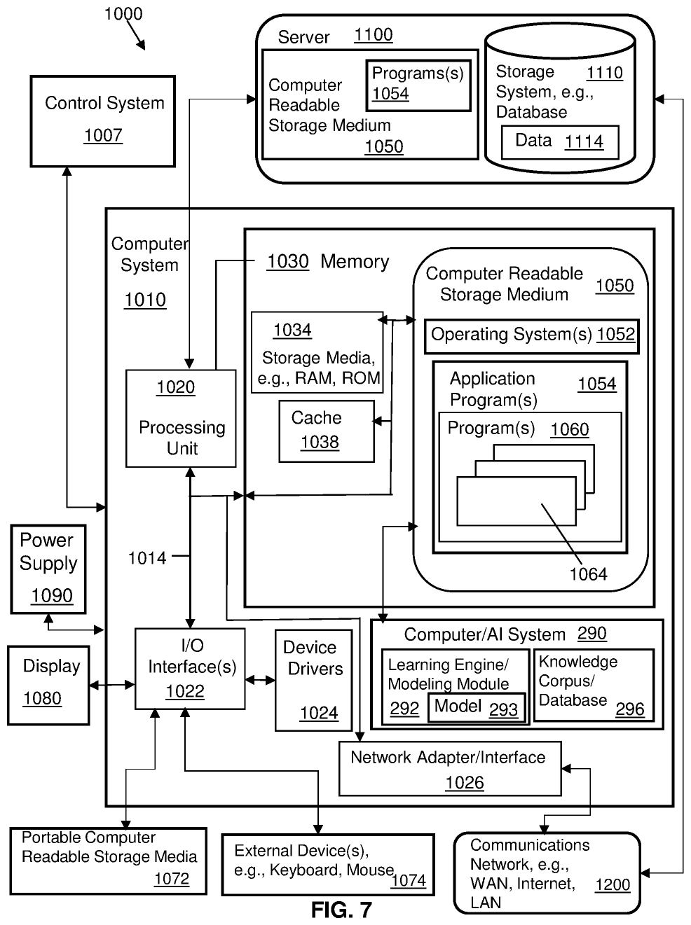

Referring to FIG. 7, an embodiment of system or computer environment 1000, according to the present disclosure, includes a computer system 1010 shown in the form of a generic computing device. The method 100, for example, may be embodied in a program 1060, including program instructions, embodied on a computer readable storage device, or a computer readable storage medium, for example, generally referred to as computer memory 1030 and more specifically, computer readable storage medium 1050. Such memory and/or computer readable storage media includes non-volatile memory or non-volatile storage, also known and referred to non-transient computer readable storage media, or non-transitory computer readable storage media. For example, such non-volatile memory can also be disk storage devices, including one or more hard drives. For example, memory 1030 can include storage media 1034 such as RAM (Random Access Memory) or ROM (Read Only Memory), and cache memory 1038. The program 1060 is executable by the processor 1020 of the computer system 1010 (to execute program steps, code, or program code). Additional data storage may also be embodied as a database 1110 which includes data 1114. The computer system 1010 and the program 1060 are generic representations of a computer and program that may be local to a user, or provided as a remote service (for example, as a cloud based service), and may be provided in further examples, using a website accessible using the communications network 1200 (e.g., interacting with a network, the Internet, or cloud services). It is understood that the computer system 1010 also generically represents herein a computer device or a computer included in a device, such as a laptop or desktop computer, etc., or one or more servers, alone or as part of a datacenter. The computer system can include a network adapter/interface 1026, and an input/output (I/0) interface(s) 1022. The I/0 interface 1022 allows for input and output of data with an external device 1074 that may be connected to the computer system. The network adapter/interface 1026 may provide communications between the computer system a network generically shown as the communications network 1200.

The computer 1010 may be described in the general context of computer system-executable instructions, such as program modules, being executed by a computer system. Generally, program modules may include routines, programs, objects, components, logic, data structures, and so on that perform particular tasks or implement particular abstract data types. The method steps and system components and techniques may be embodied in modules of the program 1060 for performing the tasks of each of the steps of the method and system. The modules are generically represented in the figure as program modules 1064. The program 1060 and program modules 1064 can execute specific steps, routines, sub-routines, instructions or code, of the program.

The method of the present disclosure can be run locally on a device such as a mobile device, or can be run a service, for instance, on the server 1100 which may be remote and can be accessed using the communications network 1200. The program or executable instructions may also be offered as a service by a provider. The computer 1010 may be practiced in a distributed cloud computing environment where tasks are performed by remote processing devices that are linked through a communications network 1200. In a distributed cloud computing environment, program modules may be located in both local and remote computer system storage media including memory storage devices.

More specifically, the system or computer environment 1000 includes the computer system 1010 shown in the form of a general-purpose computing device with illustrative periphery devices. The components of the computer system 1010 may include, but are not limited to, one or more processors or processing units 1020, a system memory 1030, and a bus 1014 that couples various system components including system memory 1030 to processor 1020.

The bus 1014 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer 1010 can include a variety of computer readable media. Such media may be any available media that is accessible by the computer 1010 (e.g., computer system, or server), and can include both volatile and non-volatile media, as well as removable and non-removable media. Computer memory 1030 can include additional computer readable media in the form of volatile memory, such as random access memory (RAM) 1034, and/or cache memory 1038. The computer 1010 may further include other removable/non-removable, volatile/non-volatile computer storage media, in one example, portable computer readable storage media 1072. In one embodiment, the computer readable storage medium 1050 can be provided for reading from and writing to a non-removable, non-volatile magnetic media. The computer readable storage medium 1050 can be embodied, for example, as a hard drive. Additional memory and data storage can be provided, for example, as the storage system 1110 (e.g., a database) for storing data 1114 and communicating with the processing unit 1020. The database can be stored on or be part of a server 1100. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1014 by one or more data media interfaces. As will be further depicted and described below, memory 1030 may include at least one program product which can include one or more program modules that are configured to carry out the functions of embodiments of the present invention.

The method(s) described in the present disclosure, for example, may be embodied in one or more computer programs, generically referred to as a program 1060 and can be stored in memory 1030 in the computer readable storage medium 1050. The program 1060 can include program modules 1064. The program modules 1064 can generally carry out functions and/or methodologies of embodiments of the invention as described herein. The one or more programs 1060 are stored in memory 1030 and are executable by the processing unit 1020. By way of example, the memory 1030 may store an operating system 1052, one or more application programs 1054, other program modules, and program data on the computer readable storage medium 1050. It is understood that the program 1060, and the operating system 1052 and the application program(s) 1054 stored on the computer readable storage medium 1050 are similarly executable by the processing unit 1020. It is also understood that the application 1054 and program(s) 1060 are shown generically, and can include all of, or be part of, one or more applications and program discussed in the present disclosure, or vice versa, that is, the application 1054 and program 1060 can be all or part of one or more applications or programs which are discussed in the present disclosure. It is also understood that a control system 1007, communicating with a computer system, can include all or part of the computer system 1010 and its components, and/or the control system can communicate with all or part of the computer system 1010 and its components as a remote computer system, to achieve the control system functions described in the present disclosure. The control system function, for example, can include storing, processing, and executing software instructions to perform the functions of the present disclosure. It is also understood that the one or more computers or computer systems shown in other figures can include all or part of the computer system 1010 and its components, and/or the one or more computers can communicate with all or part of the computer system 1010 and its components as a remote computer system, to achieve the computer functions described in the present disclosure. For example, the control system 1007 can be a representation, in all or part, of a control system depicted in other figures herein.

In an embodiment according to the present disclosure, one or more programs can be stored in one or more computer readable storage media such that a program is embodied and/or encoded in a computer readable storage medium. In one example, the stored program can include program instructions for execution by a processor, or a computer system having a processor, to perform a method or cause the computer system to perform one or more functions. For example, in one embedment according to the present disclosure, a program embodying a method is embodied in, or encoded in, a computer readable storage medium, which includes and is defined as, a non-transient or non-transitory computer readable storage medium. Thus, embodiments or examples according to the present disclosure, of a computer readable storage medium do not include a signal, and embodiments can include one or more non-transient or non-transitory computer readable storage mediums. Thereby, in one example, a program can be recorded on a computer readable storage medium and become structurally and functionally interrelated to the medium.

The computer 1010 may also communicate with one or more external devices 1074 such as a keyboard, a pointing device, a display 1080, etc.; one or more devices that enable a user to interact with the computer 1010; and/or any devices (e.g., network card, modem, etc.) that enables the computer 1010 to communicate with one or more other computing devices. Such communication can occur via the Input/Output (I/O) interfaces 1022. A power supply 1090 can also connect to the computer using an electrical power supply interface (not shown). Still yet, the computer 1010 can communicate with one or more networks 1200 such as a local area network (LAN), a general wide area network (WAN), and/or a public network (e.g., the Internet) via network adapter/interface 1026. As depicted, network adapter 1026 communicates with the other components of the computer 1010 via bus 1014. It should be understood that although not shown, other hardware and/or software components could be used in conjunction with the computer 1010. Examples, include, but are not limited to: microcode, device drivers 1024, redundant processing units, external disk drive arrays, RAID systems, tape drives, and data archival storage systems, etc.

It is understood that a computer or a program running on the computer 1010 may communicate with a server, embodied as the server 1100, via one or more communications networks, embodied as the communications network 1200. The communications network 1200 may include transmission media and network links which include, for example, wireless, wired, or optical fiber, and routers, firewalls, switches, and gateway computers. The communications network may include connections, such as wire, wireless communication links, or fiber optic cables. A communications network may represent a worldwide collection of networks and gateways, such as the Internet, that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. A network may also include a number of different types of networks, such as, for example, an intranet, a local area network (LAN), or a wide area network (WAN).

In one example, a computer can use a network which may access a website on the Web (World Wide Web) using the Internet. In one embodiment, a computer 1010, including a mobile device, can use a communications system or network 1200 which can include the Internet, or a public switched telephone network (PSTN) for example, a cellular network. The PSTN may include telephone lines, fiber optic cables, microwave transmission links, cellular networks, and communications satellites. The Internet may facilitate numerous searching and texting techniques, for example, using a cell phone or laptop computer to send queries to search engines via text messages (SMS), Multimedia Messaging Service (MMS) (related to SMS), email, or a web browser. The search engine can retrieve search results, that is, links to websites, documents, or other downloadable data that correspond to the query, and similarly, provide the search results to the user via the device as, for example, a web page of search results.

### STILL FURTHER ADDITIONAL EXAMPLES AND EMBODIMENTS

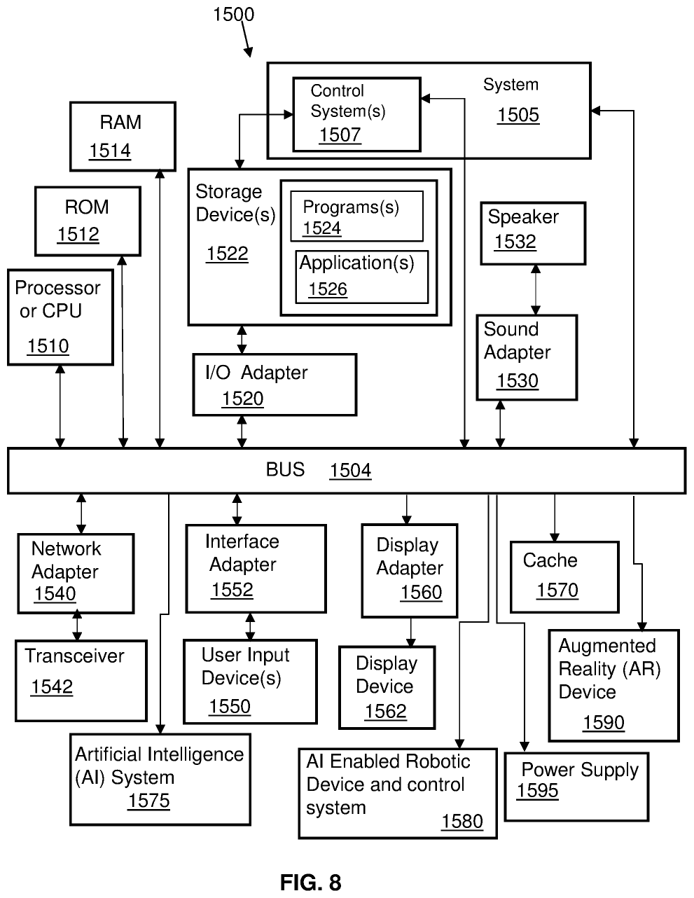

Referring to FIG. 8, an example system 1500 for use with the embodiments of the present disclosure is depicted. The system 1500 includes a plurality of components and elements connected via a system bus 1504. At least one processor (CPU) 1510, is connected to other components via the system bus 1504. A cache 1570, a Read Only Memory (ROM) 1512, a Random Access Memory (RAM) 1514, an input/output (I/O) adapter 1520, a sound adapter 1530, a network adapter 1540, a user interface adapter 1552, a display adapter 1560 and a display device 1562, are also operatively coupled to the system bus 1504 of the system 1500. An AR device 1580 can also be operatively coupled to the bus 1504. An AI enabled robotic device and robot control system 1580 can also be operatively coupled to the bus 1504. Such a robot and robot control system 1580 can incorporate all or part of embodiments of the present disclosure and discussed hereinbefore. An artificial intelligence (AI) system 1575 or an AI ecosystem can also be operatively coupled to the bus 1504. A power supply 1595 can also be operatively connected to the bus 1504 for providing power to components and for functions according to the present disclosure. An augmented reality (AR) device 1590 can also be operatively connected to the bus 1504 for providing augmented reality output to a wearable augmented reality device, such as AR glasses or an AR headset.

One or more storage devices 1522 are operatively coupled to the system bus 1504 by the I/O adapter 1520. The storage device 1522, for example, can be any of a disk storage device (e.g., a magnetic or optical disk storage device), a solid state magnetic device, and so forth. The storage device 1522 can be the same type of storage device or different types of storage devices. The storage device can include, for example, but not limited to, a hard drive or flash memory and be used to store one or more programs 1524 or applications 1526. The programs and applications are shown as generic components and are executable using the processor 1510. The program 1524 and/or application 1526 can include all of, or part of, programs or applications discussed in the present disclosure, as well vice versa, that is, the program 1524 and the application 1526 can be part of other applications or program discussed in the present disclosure.

The system 1500 can include a control system 1507 which is part of the system 1505 and can communicate with the system bus independently or as part of the system 100, and thus can communicate with the other components of the system 1500 via the system bus. In one example, the storage device 1522, via the system bus, can communicate with a control system which has various functions as described in the present disclosure. For example, the control system 1507 and system 1505 can represent, all or in part, a system and a control system as described in other embodiments depicted in the figures and described in further detail hereinbefore.

In one aspect, a speaker 1532 is operatively coupled to system bus 1504 by the sound adapter 1530. A transceiver 1542 is operatively coupled to system bus 1504 by the network adapter 1540. A display 1562 is operatively coupled to the system bus 1504 by the display adapter 1560.

In another aspect, one or more user input devices 1550 are operatively coupled to the system bus 1504 by the user interface adapter 1552. The user input devices 1550 can be, for example, any of a keyboard, a mouse, a keypad, an image capture device, a motion sensing device, a microphone, a device incorporating the functionality of at least two of the preceding devices, and so forth. Other types of input devices can also be used, while maintaining the spirit of the present invention. The user input devices 1550 can be the same type of user input device or different types of user input devices. The user input devices 1550 are used to input and output information to and from the system 1500.

### OTHER ASPECTS AND EXAMPLES

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures of the present disclosure illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### ADDITIONAL ASPECTS AND EXAMPLES

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

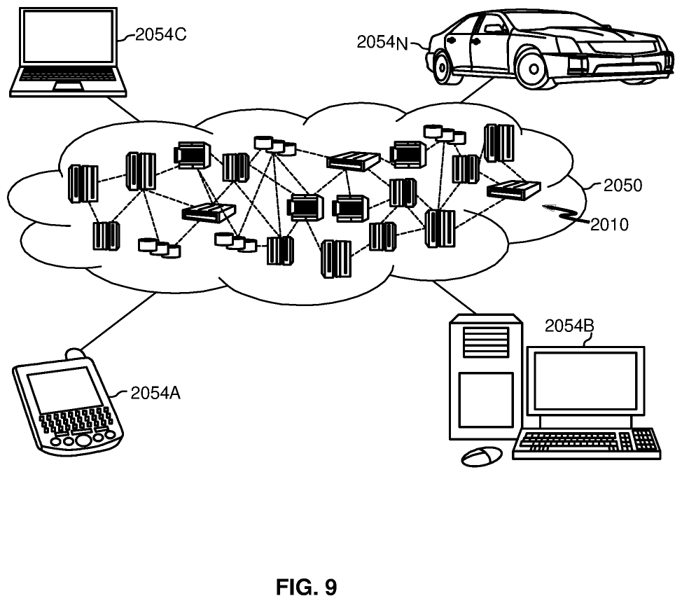

Referring now to FIG. 9, illustrative cloud computing environment 2050 is depicted. As shown, cloud computing environment 2050 includes one or more cloud computing nodes 2010 with which local computing devices used by cloud consumers, such as, for example, personal digital assistant (PDA) or cellular telephone 2054A, desktop computer 2054B, laptop computer 2054C, and/or automobile computer system 2054N may communicate. Nodes 2010 may communicate with one another. They may be grouped (not shown) physically or virtually, in one or more networks, such as Private, Community, Public, or Hybrid clouds as described hereinabove, or a combination thereof. This allows cloud computing environment 2050 to offer infrastructure, platforms and/or software as services for which a cloud consumer does not need to maintain resources on a local computing device. It is understood that the types of computing devices 2054A-N shown in FIG. 9 are intended to be illustrative only and that computing nodes 2010 and cloud computing environment 2050 can communicate with any type of computerized device over any type of network and/or network addressable connection (e.g., using a web browser).

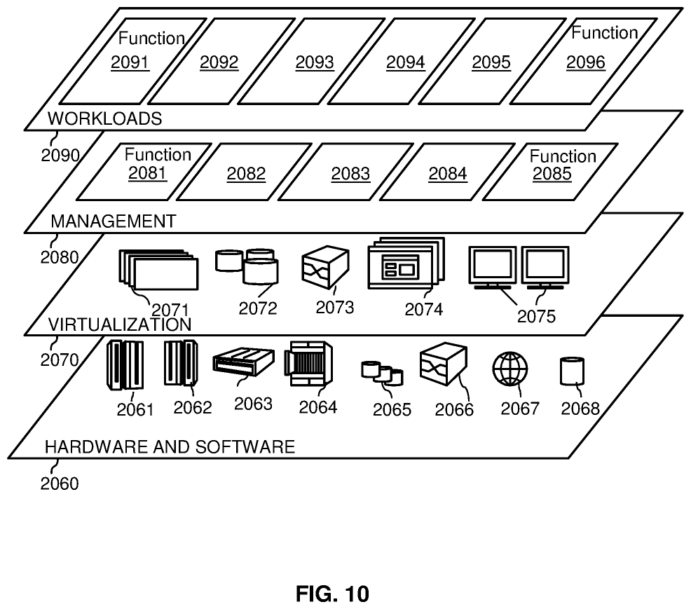

Referring now to FIG. 10, a set of functional abstraction layers provided by cloud computing environment 2050 (FIG. 9) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 2060 includes hardware and software components. Examples of hardware components include: mainframes 2061; RISC (Reduced Instruction Set Computer) architecture based servers 2062; servers 2063; blade servers 2064; storage devices 2065; and networks and networking components 2066. In some embodiments, software components include network application server software 2067 and database software 2068.

Virtualization layer 2070 provides an abstraction layer from which the following examples of virtual entities may be provided: virtual servers 2071; virtual storage 2072; virtual networks 2073, including virtual private networks; virtual applications and operating systems 2074; and virtual clients 2075.

In one example, management layer 2080 may provide the functions described below. Resource provisioning 2081 provides dynamic procurement of computing resources and other resources that are utilized to perform tasks within the cloud computing environment. Metering and Pricing 2082 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 2083 provides access to the cloud computing environment for consumers and system administrators. Service level management 2084 provides cloud computing resource allocation and management such that required service levels are met. Service Level Agreement (SLA) planning and fulfillment 2085 provide pre-arrangement for, and procurement of, cloud computing resources for which a future requirement is anticipated in accordance with an SLA.

Workloads layer 2090 provides examples of functionality for which the cloud computing environment may be utilized. Examples of workloads and functions which may be provided from this layer include: mapping and navigation 2091; software development and lifecycle management 2092; virtual classroom education delivery 2093; data analytics processing 2094; transaction processing 2095; and computer modeling using machine learning 2096, for example, training a computer data model of data distribution using a training data set.

What is claimed is:

1. A computer-implemented method for training data models using machine learning, comprising:
training a computer data model of data distribution using a training data set, the training data set including training data and additional training data, the training data and the additional training data being represented by layers of data representing the data distribution of the training data set;
iteratively training the computer data model using the additional training data for each of the layers of the training data set;
adding statistical noise randomly to each of the layers of the training data set;
detecting data variations in each of the layers of the additional training data;
diluting the data variations in each of the additional layers of the training data; and
retraining the computer data model for the training data set using the diluted data variations in each of the layers of the additional training data.

2. The method of claim 1, wherein the additional data being selected using parameters, for each of the layers of data, respectively.

3. The method of claim 1, further comprising:
identifying a principal component of the data variations.

4. The method of claim 1, further comprising:
identifying a principal component of the data variations; and
adding a principal component of the data variations to each of the layers of the training data set, as at least part of the diluting of the data variations in each of the additional layers of the training data set.

5. The method of claim 1, wherein the adding of the statistical noise is implemented using an adversarial generation network, wherein a generator randomly generates the statistical noise and merges it with the parameters at each layer of the training data set.

6. The method of claim 1, wherein the detecting of data variations in each of the layers of the additional training data includes detecting outlier data points in response to generating iterations of the computer model.

7. The method of claim 1, wherein the statistical noise is Gaussian noise.

8. A system for training data models using machine learning, which comprises:
a computer system comprising; a computer processor, a computer-readable storage medium, and program instructions stored on the computer-readable storage medium being executable by the processor, to cause the computer system to perform the following functions to:
train a computer data model of data distribution using a training data set, the training data set including training data and additional training data, the training data and the additional training data being represented by layers of data representing the data distribution of the training data set;
iteratively train the computer data model using the additional training data for each of the layers of the training data set;
add statistical noise randomly to each of the layers of the training data set;
detect data variations in each of the layers of the additional training data;
dilute the data variations in each of the additional layers of the training data; and
retrain the computer data model for the training data set using the diluted data variations in each of the layers of the additional training data.

9. The system of claim 8, wherein the additional data being selected using parameters, for each of the layers of data, respectively.

10. The system of claim 8, further comprising:
identifying a principal component of the data variations.

11. The system of claim 8, further comprising the following function to:
identify a principal component of the data variations; and
add a principal component of the data variations to each of the layers of the training data set, as at least part of the diluting of the data variations in each of the additional layers of the training data set.

12. The system of claim 8, wherein the adding of the statistical noise is implemented using an adversarial generation network, wherein a generator randomly generates the statistical noise and merges it with the parameters at each layer of the training data set.

13. The system of claim 8, wherein the detect data variations in each of the layers of the additional training data includes the function to detect outlier data points in response to generating iterations of the computer model.

14. The system of claim 8, wherein the statistical noise is Gaussian noise.

15. A computer program product for training data models using machine learning, the computer program product comprising a computer readable storage medium having program instructions embodied therewith, the program instructions executable by a computer to cause the computer to perform functions, by the computer, comprising the functions to:
train a computer data model of data distribution using a training data set, the training data set including training data and additional training data, the training data and the additional training data being represented by layers of data representing the data distribution of the training data set;
iteratively train the computer data model using the additional training data for each of the layers of the training data set;
add statistical noise randomly to each of the layers of the training data set;
detect data variations in each of the layers of the additional training data;
dilute the data variations in each of the additional layers of the training data; and
retrain the computer data model for the training data set using the diluted data variations in each of the layers of the additional training data.

16. The computer program product of claim 15, wherein the additional data being selected using parameters, for each of the layers of data, respectively.

17. The computer program product of claim 15, further comprising the function to:
identify a principal component of the data variations.

18. The computer program product of claim 15, further comprising the functions to:
identify a principal component of the data variations; and
add a principal component of the data variations to each of the layers of the training data set, as at least part of the diluting of the data variations in each of the additional layers of the training data set.

19. The computer program product of claim 15, wherein the adding of the statistical noise is implemented using an adversarial generation network, wherein a generator randomly generates the statistical noise and merges it with the parameters at each layer of the training data set.

20. The computer program product of claim 15, wherein the function to detect data variations in each of the layers of the additional training data includes detecting outlier data points in response to generating iterations of the computer model.
